(19) United States
(12) Patent Application Publication
(10) Pub. No.: US 2016/0028620 A1
(43) Pub. Date: Jan. 28, 2016

(54) SOFTWARE-DEFINED NETWORKING CONTROLLER CACHE

(71) Applicant: ALCATEL-LUCENT USA INC., Murray Hill, NJ (US)

(72) Inventors: Adiseshu HARI, Holmdel, NJ (US); T.V. LAKSHMAN, Morganville, NJ (US)

(21) Appl. No.: 14/444,268

(22) Filed: Jul. 28, 2014

(51) Int. Cl. H04L 12/721; H04L 12/725

(52) U.S. Cl. CPC H04L 45/38; H04L 45/30

(57) ABSTRACT

An illustrative example software-defined network (SDN) switch includes a switch portion including an input port for receiving at least one packet. The switch portion includes an output port for forwarding the at least one packet. The switch portion includes at least one stored rule. The switch portion forwards the at least one packet based on the at least one stored rule based on a determination that the packet is of a first type corresponding to the stored rule. A controller cache includes information indicating how the switch portion should forward the at least one packet based on a determination that the packet is of a second type that does not correspond to the at least one stored rule. The switch portion communicates with the controller cache to obtain an indication of how to forward the packet based on a determination that the packet is of the second type.

### BACKGROUND

A software-defined network (SDN) is an approach to handling data communications that is intended to address growing trends in data communication. For example, computing and storage needs are more dynamic than ever. A SDN is intended to avoid the limitations of a static network architecture of a conventional network, which may be ill-suited to the dynamics of current trends in data communications. A SDN involves the physical separation of the network control plane from the forwarding plane and includes a control plane that controls several devices

One type of device within a SDN is a SDN switch. SDN switches may be designed to support two types of data flows. A SDN switch handles reactive flows by forwarding the flow packets to a SDN controller for handling. A SDN switch handles proactive flows by itself by forwarding the flow packets to an appropriate output port based on rules previously installed into the SDN switch by the SDN controller.

Proactive flows may be processed at line speed, which tends to be efficient. Reactive flows, on the other hand, include processing time for communicating between the SDN switch and the SDN controller. The time required to process a reactive flow includes the round trip time between the switch and the controller and the time it takes the controller to process the packet. Reactive flow processing is typically multiple orders of magnitude slower than the line speed of the switch (e.g., milliseconds compared to nanoseconds). Reactive flow processing is fundamental to the operation of SDNs. The latency associated with reactive flow processing may be considered a limitation on SDNs.

### SUMMARY

An illustrative example software-defined network (SDN) switch includes a switch portion including an input port for receiving at least one packet. The switch portion includes an output port for forwarding the at least one packet. The switch portion includes at least one stored rule. The switch portion forwards the at least one packet based on the at least one stored rule based on a determination that the packet is of a first type corresponding to the stored rule. A controller cache includes information indicating how the switch portion should forward the at least one packet based on a determination that the packet is of a second type that does not correspond to the at least one stored rule. The switch portion communicates with the controller cache to obtain an indication of how to forward the packet if the packet is of the second type.

In an example embodiment of a switch having one or more features of the switch of the previous paragraph, the controller cache communicates with a SDN controller remote from the SDN switch; the controller cache appears to the SDN controller as a SDN switch; and the SDN controller and the controller cache communicate using a protocol for communications between the SDN controller and a SDN switch.

In an example embodiment of a switch having one or more features of the switch of either of the previous paragraphs, the controller cache appears to the switch portion as a SDN controller; and the controller cache and the switch portion communicate using a protocol for communications between a SDN controller and a SDN switch.

In an example embodiment of a switch having one or more features of the switch of any of the previous paragraphs, the controller cache information comprises a plurality of rules for forwarding packets from the switch portion; the at least one stored rule being at least one of a more recently used rule or a more frequently used rule compared to the plurality of rules of the controller cache information.

In an example embodiment of a switch having one or more features of the switch of any of the previous paragraphs, the controller cache information comprises at least one algorithm for dynamically determining how to forward a plurality of types of packets.

In an example embodiment of a switch having one or more features of the switch of any of the previous paragraphs, the at least one algorithm comprises a plurality of packet forwarding algorithms.

In an example embodiment of a switch having one or more features of the switch of any of the previous paragraphs, the cache processor uses the at least one algorithm and information from a separate source for determining how to forward the packet based on a determination that the packet is of the second type.

An illustrative embodiment of a communication system includes a software-defined network (SDN) switch including an input port for receiving at least one packet. The SDN switch includes an output port for forwarding the at least one packet. The SDN switch includes at least one stored rule. The SDN switch forwarding the at least one packet based on the at least one stored rule based on a determination that the packet is of a first type corresponding to the stored rule. A SDN controller is at a first communication distance from the SDN switch. The SDN controller includes information indicating how the SDN switch should forward the at least one packet based on a determination that the packet is of a second type that does not correspond to the at least one stored rule. A controller cache is at a second communication distance from the SDN switch. The second communication distance is less than the first communication distance. The controller cache includes a duplicate of at least some of the information of the SDN controller. The SDN switch communicates with the controller cache based on a determination that the at least one packet is of the second type.

In an example embodiment of a system having one or more features of the system of the previous paragraph, the controller cache is collocated with the SDN switch.

In an example embodiment of a system having one or more features of the system of either of the previous paragraphs, the first communication distance comprises a first round trip time for communications between the SDN switch and the SDN controller; and the second communication distance comprises a second, shorter round trip time for communications between the SDN switch and the controller cache.

In an example embodiment of a system having one or more features of the system of any of the previous paragraphs, the controller cache includes a processor; the processor determines whether the information of the controller cache indicates how to forward the at least one packet when the packet is of the second type; and the processor requests information from the SDN controller regarding how to forward the at least one packet based on a determination that the information of the controller cache does not indicate how to forward the at least one packet.

In an example embodiment of a system having one or more features of the system of any of the previous paragraphs, the processor requires information from a separate source; and the SDN controller directs the information from the separate source to the controller cache.

In an example embodiment of a system having one or more features of the system of any of the previous paragraphs, the SDN controller information and the controller cache information respectively comprise a plurality of predetermined rules; the controller cache appears to the SDN controller as a SDN switch; and the SDN controller and the controller cache communicate using a protocol for communications between the SDN controller and a SDN switch.

In an example embodiment of a system having one or more features of the system of any of the previous paragraphs, the SDN controller information and the controller cache information respectively comprise at least one algorithm for dynamically determining how to forward a plurality of types of packets.

In an example embodiment of a system having one or more features of the system of any of the previous paragraphs, the controller cache information comprises at least one of a predetermined rule and an algorithm for dynamically determining how to forward a packet; and the SDN controller information comprises at least one of a predetermined rule and an algorithm for dynamically determining how to forward a packet.

An example embodiment of a method of processing a packet at a switch in a software-defined network (SDN), comprises the steps of: receiving at least one packet at the switch; forwarding the at least one packet from the switch according to at least one stored rule stored at the switch based on a determination that the packet is of a first type corresponding to the stored rule; communicating between the switch and a controller cache based on a determination that the packet is of a second type that does not correspond to the stored rule; using information stored at the controller cache to determine a manner of forwarding the packet based on a determination that the packet is of the second type; communicating the determined manner from the controller cache to the switch; and forwarding the packet from the switch according to the determined manner.

An embodiment of a method having one or more features of the method of the previous paragraph includes communicating between the controller cache and a SDN controller remote from the switch; wherein the controller cache appears to the SDN controller as a SDN switch; and communicating between the SDN controller and the controller cache using a protocol for communications between the SDN controller and a SDN switch.

An embodiment of a method having one or more features of the method of either of the previous paragraphs includes communicating between the controller cache and the switch portion using a protocol for communications between a SDN controller and a SDN switch; wherein the controller cache appears to the switch as a SDN controller.

In an embodiment of a method having one or more features of the method of any of the previous paragraphs, the controller cache information comprises a plurality of rules for forwarding packets from the switch portion; the at least one stored rule is at least one of a more recently used rule or a more frequently used rule compared to the plurality of rules of the controller cache information.

An embodiment of a method having one or more features of the method of any of the previous paragraphs includes dynamically determining the manner of forwarding based on at least one algorithm stored at the controller cache.

The various features and advantages of at least one disclosed embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a software-defined network (SDN) designed according to an embodiment of this invention.

FIG. 2 schematically shows selected portions of the embodiment of FIG. 1 in somewhat more detail.

FIG. 3 schematically shows selected portions of the embodiment of FIG. 1 in somewhat more detail.

FIG. 4 schematically shows example features of an example SDN switch and a SDN controller and represents how those features may be involved in flow processing.

FIG. 5 schematically shows selected features of an example SDN switch and a SDN controller and how those features may be involved in an example flow process.

FIG. 6 schematically illustrates an example SDN switch configuration.

FIG. 7 schematically illustrates another example SDN switch configuration.

FIG. 8 is a flowchart diagram summarizing an example method of handling a data communication in a SDN designed according to embodiment of this invention.

### DETAILED DESCRIPTION

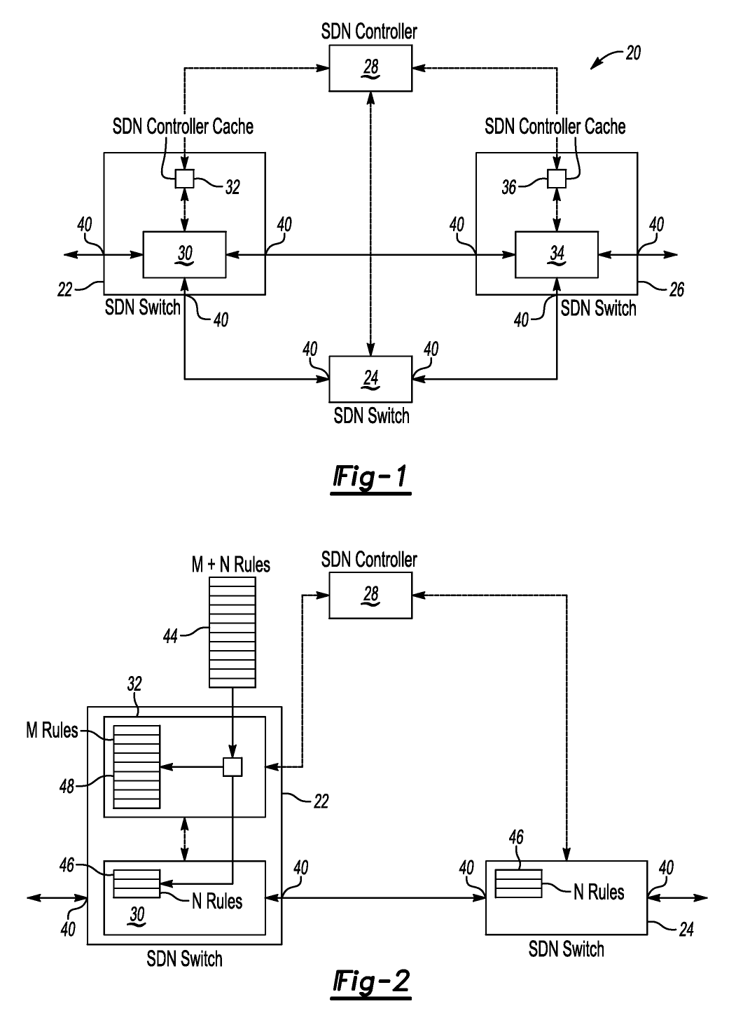

FIG. 1 schematically illustrates selected portions of a software-defined network (SDN) 20. SDN switches 22, 24 and 26 are configured to handle packets moving through the SDN 20 as part of a data communication, for example. A SDN controller 28 controls operation of the SDN switches 22, 24 and 26. In the illustrated example, the controller 28 controls the SDN switch 24 in a conventional manner. In this example, the SDN switches 22 and 26 are configured for a different type of interaction with the SDN controller 28 to reduce latency associated with reactive flow processing.

The SDN switch 22 includes a switch portion 30 and a SDN controller cache 32. The SDN switch 26 includes a switch portion 34 and a SDN controller cache 36. According to the example of FIG. 1, the controller caches 32 and 36 are schematically shown as part of the corresponding switch. In other examples, the controller cache may be physically separate from other portions of the switch but in much closer proximity to the switch than the SDN controller 28 such that any communications between the switch and the controller cache have a lower latency compared to communications between the switch and the SDN controller 28.

Each of the switches in FIG. 1 includes input ports and output ports 40 for forwarding packets through the network. According to the illustrated configuration, each of the ports 40 may serve as an input port or an output port depending on the direction of communication. The SDN switches 22 and 26 receive a packet at the input port and forward it through the output port according to a rule stored in the switch portion based on a determination that the packet is of a type corresponding to that rule. The switches 22 and 26 use information from the SDN controller cache 32 and 36, respectively, for forwarding a packet that is of another type that does not correspond to the rule stored in the switch portion 30.

FIG. 2 schematically illustrates the SDN switch 22 and the SDN switch 24 in somewhat more detail. Those skilled in the art will realize that SDN switches have a variety of features that may not be shown in the drawings. As shown in FIG. 2, the SDN switch 22 includes the switch portion 30 and the SDN controller cache 32. In this example, the SDN controller 28 communicates M+N rules schematically shown at 44 to the SDN controller 32. N of those rules are forwarded to the switch portion 30 as schematically shown at 46. The N rules are stored in the switch portion 30. In this example, the switch portion 30 includes a memory portion that is useful for storing a plurality of predetermined rules that indicate how the switch should forward packets of various types corresponding to those rules. The controller cache 32 stores or maintains the M rules schematically shown at 48 within the controller cache 32.

In one example, the SDN controller 28 instructs the SDN controller cache 32 on which of the N rules should be stored in the switch portion 30. During an initialization phase, the physical capabilities of the SDN switch 22 are communicated to the SDN controller 28. In the example of FIG. 2, the SDN controller cache 32 obtains that information from the switch portion 30 and forwards it to the SDN controller 28. Part of the information available to the SDN controller 28 is the number of rules N that can be stored in the switch portion 30. The SDN controller cache 32 communicates the number of rules it can maintain to the SDN controller 28. According to one embodiment, the SDN controller 28 prioritizes the M+N rules and communicates them in an order that the SDN controller cache 32 interprets or uses to decide which the N rules will be provided to the switch portion 30. In one example, the first N rules in the sequence of rules provided by the SDN controller 28 are those that should be stored in the switch portion 30. The SDN controller cache 32 maintains the remainder (e.g., the other M rules) within the SDN controller cache 32.

FIG. 2 also shows the SDN switch 24 for comparison to appreciate the differences between the SDN switch 22 and the SDN switch 24. The SDN switch 24 does not have an associated SDN controller cache. Instead, the SDN switch 24 only has enough memory to store N rules as schematically shown at 46. During an initialization phase of the SDN switch 24, that switch communicates directly with the SDN controller 28 and obtains the N rules in a known manner.

During a data communication session, a packet may arrive at the SDN switch 22. The switch portion 30 determines whether the type of that packet corresponds to any of the N rules shown at 46. If the packet type corresponds to at least one of those rules shown at 46, the switch portion 30 handles that packet in a proactive flow manner. The packet is forwarded according to the corresponding rule stored at the switch portion 30.

Other packets of the data communication will not be of a type corresponding to any of the N rules stored by the switch portion 30. In such an instance, the switch portion 30 communicates with the SDN controller cache 32 to obtain information indicating how the switch portion should forward that packet. The SDN controller cache 32 receives information from the switch portion 30 regarding the packet in question. The SDN controller cache 32 determines how to forward that packet based on at least a corresponding one of the M rules stored at 48 in the SDN controller cache 32. That information is then communicated to the switch portion 30 so that the switch portion 30 may forward that packet accordingly.

Given that the SDN controller cache 32 is incorporated as part of the SDN switch 22 in this example, the latency associated with handling a packet in a reactive flow manner is significantly reduced compared to the latency associated with the SDN switch 24 handling that type of packet. The round trip time for communicating between the switch portion 30 and the SDN controller cache portion 32 is significantly less than the round trip time (e.g., communication distance) associated with communications between the SDN switch 24 and the SDN controller 28. The longer or greater communication distance (e.g., round trip time) between the SDN switch 24 and the SDN controller 28 increases the flow processing time compared to a reactive flow processing time that may be accomplished by the SDN switch 22 using the SDN controller cache 32.

The SDN controller cache 32 may be incorporated into a SDN switch by designing the switch to have the SDN controller cache 32 incorporated as part of the hardware of that switch. Existing hardware SDN switches may have spare processor cores that were intended for future application and upgrades. Such a value added, additional processor is utilized in one embodiment of this invention to run the cache of the SDN controller cache 32 within the memory constraints imposed by the embedded switch design.

In some embodiments, the SDN switches may be software switches located in a hypervisor to serve switch traffic of virtual machines running on the hypervisor. Some software switches do not suffer from a limitation on the flow table and, therefore, may not need a separate software data cache such as the SDN controller cache 32 in the example of FIG. 2. There are software switches that are only available in a locked down, binary form without an ability to change the rule table size. For such SDN switches, a software data cache may reside in the hypervisor as a separate entity to provide the SDN controller cache capability like that of the SDN controller cache 32 in the example of FIG. 2.

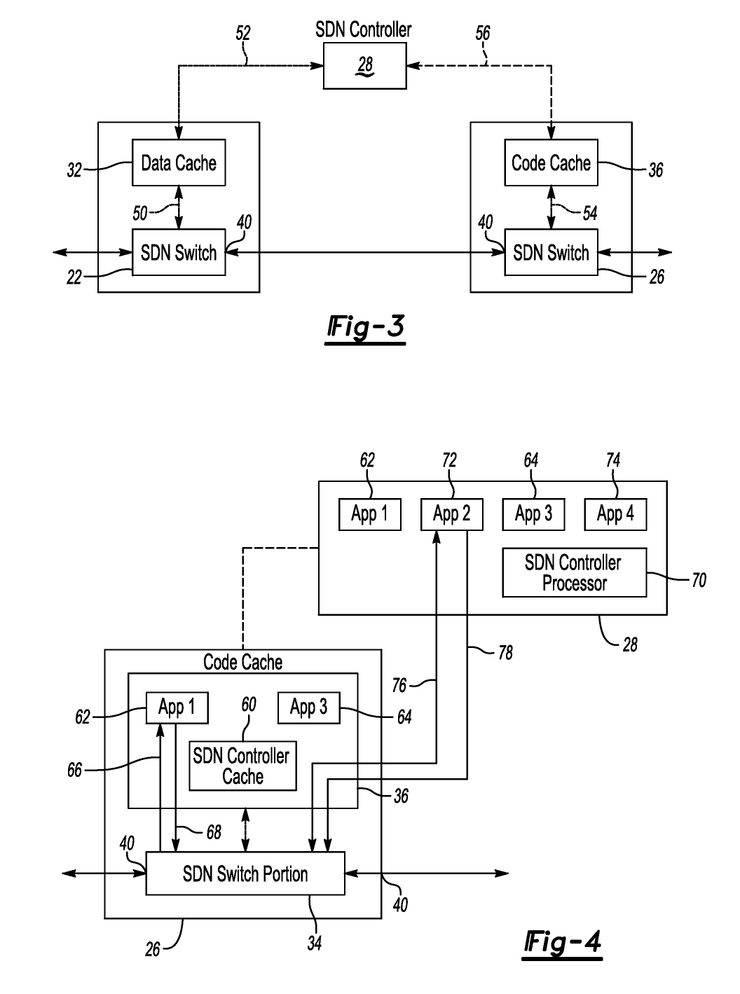

FIG. 3 schematically illustrates the SDN switch 22 including the SDN controller cache 32, which is implemented as a data cache. The SDN controller cache 32 in this example communicates with the switch portion of the SDN switch 22 over a communication link schematically shown at 50. The switch portion of the SDN switch 22 appears as an SDN switch to the SDN controller cache 32 and the SDN controller cache 32 appears as an SDN controller to the switch portion of the SDN switch 22 over the link 50. A protocol for communications between a SDN controller and a SDN switch is used for the communications over the link 50.

Another link 52 is schematically shown between the SDN controller cache 32 and the SDN controller 28. Over the link 52, the SDN controller cache 32 appears as a SDN switch to the SDN controller 28. A known protocol for communicating between the SDN controller 28 and a SDN switch is used over the link 52. One feature of this arrangement is that the SDN controller 28 need not be modified and a known protocol may be used for communications with the controller cache 32. This approach of having the SDN controller cache 32 appear as a controller to the switch portion 30 on the link 50 and as a switch to the SDN controller 28 on the link 52 allows the SDN controller cache 32 to effectively be transparent such that the functionality of the switch 22 and the controller 28 for communicating with each other need not be altered.

During an initialization phase when the SDN controller 28 queries the features of the SDN switch 22, the SDN controller cache 32 indicates a table size that is the sum of the table sizes of the switch and the SDN controller cache 32. When the SDN switch 22 sends out a reactive flow, the SDN controller cache 32 intercepts that on the control path 50 and responds directly if the reactive flow entry (e.g., rule) is stored locally in the SDN controller cache 32. This significantly reduces the round trip time for reactive flow resolution. In some instances, the reactive flow rule will not be cached at the SDN controller cache 32. In those instances, the SDN controller cache 32 communicates with the SDN controller 28 and the uncached flow is resolved at the SDN controller 28.

In some instances, the SDN controller cache 32 may replace one of the rules at 46 within the switch portion with a rule from the SDN controller cache portion 32 so that future packets of the type corresponding to that rule may be handled by the switch portion 30 in a proactive flow manner. In other examples, the SDN controller cache 32 will change one or more of the rules stored at 46 in the switch portion 30 responsive to an instruction from the SDN controller 28. In other examples, once the N rules are stored in the switch portion 30 those are not changed until an update of the switch, for example.

For storing rules in the switch portion 30, one embodiment includes active rule usage monitoring to manage the cache. This example includes monitoring usage statistics for each flow and determining the set of most active flows to ensure that rules corresponding to the more active types of flows are stored in the switch portion. One advantage to this approach is that it does not involve the SDN controller 28 for deciding the partitioning of rules between the switch portion 30 and the SDN controller cache 32.

Some examples include a replacement policy as part of the SDN controller cache 32 to swap policies or rules from the switch portion 30 into the cache 32.

One example includes monitoring least recently used and least frequently used rules and swapping those from the switch portion 30 to the cache 32 and replacing them in the switch portion 30 with rules that have been more frequently or more recently used. In some examples, the N most used rules (e.g., the most frequently used, the most recently used, or both) are stored in the switch on a periodic basis with the remaining rules stored in the cache portion 32 to increase the likelihood that a proactive flow method may be used for as many packets as possible received at the switch.

In the example of FIG. 3, the SDN controller cache 32 may be referred to as a data cache because it stores rules. The SDN controller cache 36 of the SDN switch 26 may be referred to as a code cache because it stores applications or algorithms used for dynamically determining how to process a particular packet of a particular type. In this instance, the SDN controller cache 36 serves some of the functions of the SDN controller 28 where the SDN controller 28 includes an application layer for using algorithms or logic for determining how to handle a particular type of packet. The code cache 36 may be considered as if it were part of a hierarchical SDN controller with the SDN controller cache 36 operating at the lowest level of the hierarchy. The SDN controller hierarchy used in code caching, such as that shown in FIG. 3, is designed to speed up reactive flow look up. The SDN controller cache 36 in this example effectively runs the same logic as at least some of the logic that runs at the SDN controller 28.

Some caching logic requires frequent updates, such as load balancing based on instantaneous server load. That type of caching may not be suitable if a large number of SDN controller caches 38 are within the network as each of those would have to be updated, which introduces scaleability problems. Additionally, logic that requires complex and time consuming processing may not be suitable to be run on the low throughput, general processor cores available in embedded devices of some SDN switches.

The type of logic or algorithm that would be useful for storing within a code cache such as the cache 36 is the type that implements fairly straightforward logic, such as load balancing among a small number of servers, header checking for special IP, ICMP, TCP or application headers, or maintaining blacklists. This type of code caching may be suitably performed at the type of processor that is embedded in an SDN switch. In some embodiments, reactive flow processing logic that does not require coordination with external entities or high frequency updates and can be done with low processing power is the type of logic stored in the SDN controller cache 36. Utilizing code caching is likely to provide more of an advantage with a software SDN switch compared to a hardware SDN switch.

FIG. 4 schematically illustrates an example implementation of a code cache within the SDN controller cache 36. In the illustration, the controller cache 36 is schematically divided into a cache processor portion 40 and cache applications 62 and 64. In this example, the applications 62 and 64 correspond to applications 62 and 64 maintained by the SDN controller 28.

Assume a packet arrives at the SDN switch 26 that does not correspond to a prestored rule in the switch portion 34. A query at 66 is made to obtain information regarding how to process that packet. This query is intercepted by the SDN controller cache 36 and processed using the application 62. A response 68 is provided to the switch portion 34, which handles the packet accordingly.

For packets that do not correspond to a prestored rule in the SDN switch portion 34 or to either of the applications 62 or 64, a processor 70 of the SDN controller 28 determines which of the applications maintained by the SDN controller 28 will provide information for how to process that packet. In FIG. 4 a query is schematically shown at 76, which passes through the SDN controller cache 36 from the switch portion 34 to the SDN controller 28. The SDN controller processor 70 determines that the application 72, which is not maintained in the cache 36, resolves how that packet should be processed. At 78, that information is communicated back through the cache 36 to the switch portion 34 for handling that packet.

A regular SDN controller exposes an API used by SDN applications to register for flows of interest. The API may be network based or for local execution, such as in an operating system. The code cache 36 shown in FIG. 4 is based on a model of an SDN controller with an API supporting locally executing logic. The API in one example is Java-based and the downloaded code is also assumed to be Java-based, which shields the code from the actual processor instruction set. Any other high level interpreted language, such as Microsoft's .NET, may be used.

The features shown in FIG. 4 include the ability to have a relatively small set of applications stored within the code cache 36 compared to the number of applications maintained by the SDN controller 28. In this example, the SDN controller 28 probes the code cache 36 to determine its resource limit Based on those limitations, the SDN controller 28 decides which applications may be downloaded to the code cache 36. In one example, the SDN controller 28 has the capability of determining different capacities of different code caches and selecting different applications accordingly. It is possible to download only portions of some applications to the code cache while maintaining other portions of those applications at the SDN controller 28, depending on the type of application. Of course, the goal is to streamline reactive flow processing so dividing up an application in this manner should take into account whether such a division will introduce latency associated with reactive flow processing.

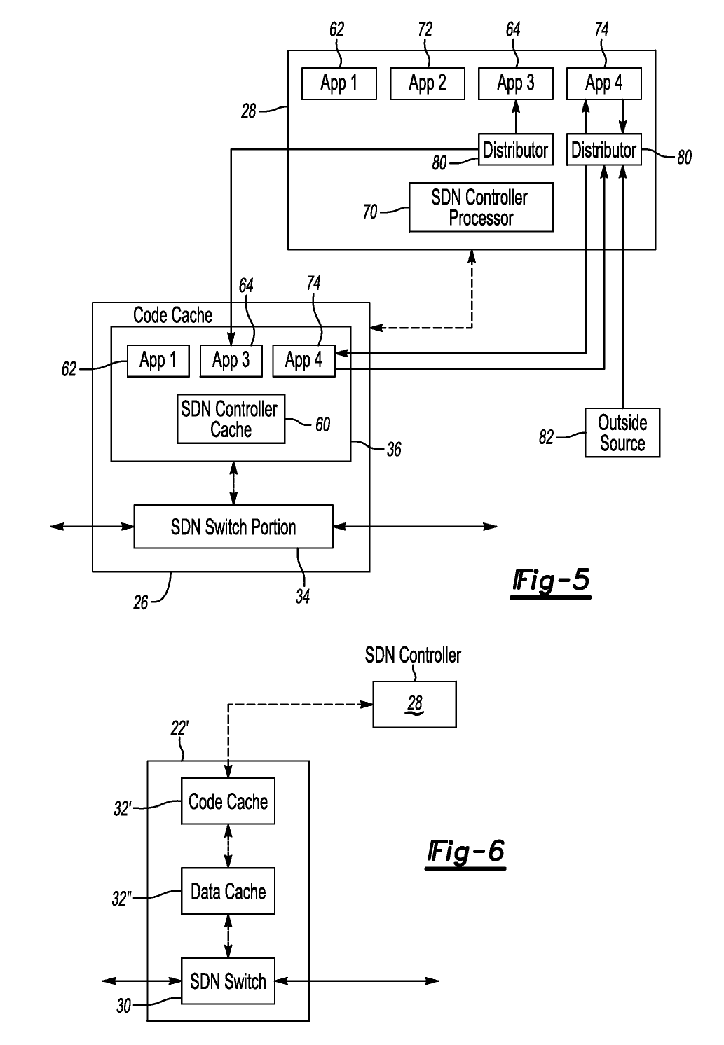

In one example, the SDN controller 28 dynamically updates the cached applications. For example, SDN applications may require dynamic inputs to operate properly. Load balancers typically need the current load on each server, firewalls typically need to have updated databases, and flow routing applications need periodic traffic matrix inputs. FIG. 5 schematically illustrates an approach for handling such situations. In this example, the SDN controller 28 includes distributors 80 configured for providing information to the applications stored at the SDN controller 28 and the applications that are part of the code cache 36. For example, information from an outside source schematically shown at 82 is received by the SDN controller 28 as a dynamic input for one or more of the applications 62, 64, 72, 74 stored at the SDN controller 28. That same information may be broadcast using the distributor 80 to the application 64 stored in the code cache 36. Broadcasting information from the SDN controller 28 in this manner maintains all of the applications within various code caches in the network in a consistent state with the corresponding applications in the SDN controller 28. Utilizing the SDN controller 28 for broadcasting such updates to multiple code caches eliminates a requirement for external entities to be aware of each of the potentially numerous code caches within a network. Additionally, utilizing the SDN controller 28 as a hub for broadcasting such information improves security and scaleability within the network. Further, utilizing distributor features within the SDN controller 28 allows for the updating schematically shown in FIG. 5 to be implemented transparent to the applications.

FIG. 5 also shows how to handle a dynamic push pull instance in which the SDN controller application is dependent on state information from an external input and a locally generated state. For example, consider the application 74 within the code cache 36. When that application results in a created state in the code cache 36, that information may be shared globally through the network by being provided to the distributor portion 80 of the SDN controller 28, then to the application 74 stored in the SDN controller 28, and broadcast to other code caches within the network. For example, consider a learning bridge in which the bridge learns about the MAC addresses of the network by absorbing the source MACs of incoming frames. In this case, the distributor 80 takes in not only the external inputs such as those from the outside source 82 but also the outputs generated by various code caches and the original application. The distributor 80 distributes all this information so that all copies of the application, whether in the SDN controller 28 or in a variety of code caches within a network, see the same state. In some instances, an application may need to be altered so that it is capable of accepting updates from other application copies in addition to being able to accept updates from an external source.

In some examples, a cache code replacement policy decides which of the applications from the SDN controller 28 will be stored in the code cache 36 of a switch. One approach includes insuring that the local code caches associated with the switches do not maintain a least recently used or least frequently used application. Those may be replaced with more recently or more frequently used applications on an occasional basis and the frequency of such updates will depend on the configuration of the network, the SDN controller or the code caches involved in that particular implementation.

FIG. 6 schematically illustrates an arrangement of an SDN switch 22′ that includes an SDN switch portion 30, a code cache 32′ and a data cache 32″. This is an example implementation in which the SDN controller cache associated with the switch 22′ has the data cache or rule storing features described above and the code cache or application storing features described above.

FIG. 7 schematically illustrates an arrangement in which the code cache 32′ and the data cache 32″ are maintained with the SDN controller cache of a switch 22′. A request steering module 90 acts as the interface between the switch portion 30, the caches 32′ and 32″, and the SDN controller 28. The request steering module 90 determines when a type of packet corresponds to a rule stored in the data cache 32′, corresponds to an application maintained within the code cache 32′ or requires communicating with the SDN controller 28 for resolving that flow.

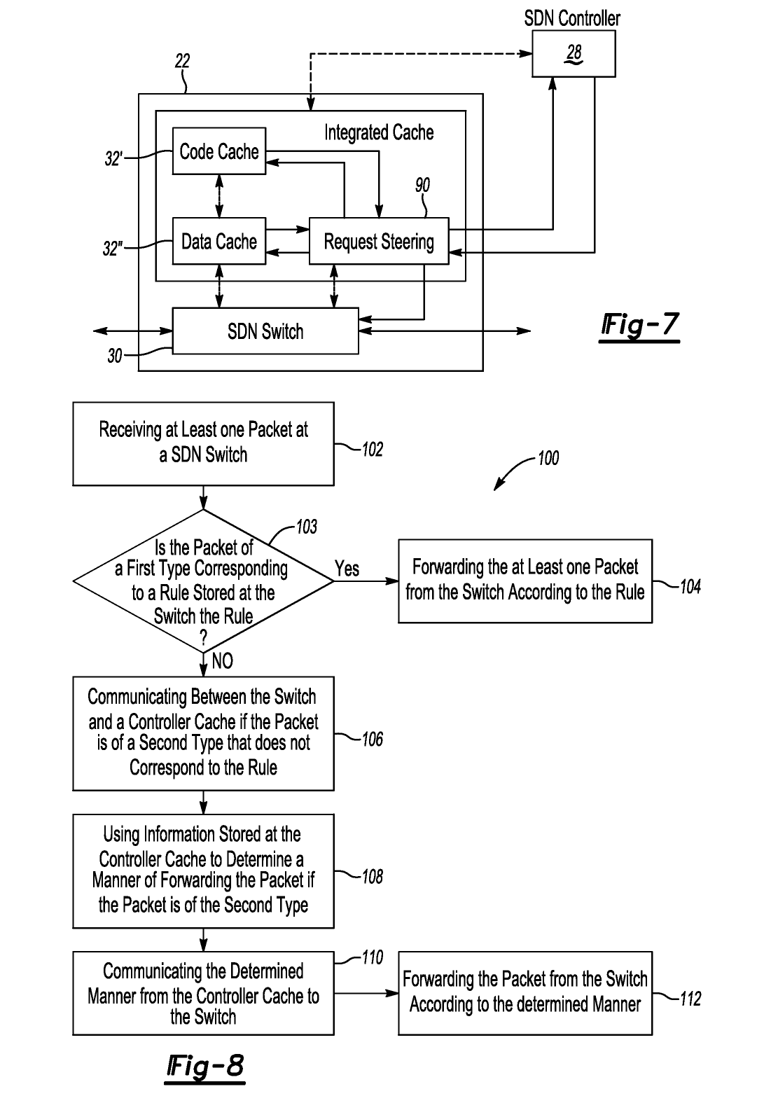

FIG. 8 is a flowchart diagram summarizing an example method for handling a data communication. The flowchart 100 begins at 102 where at least one packet is received at an SDN switch. The SDN switch determines at 103 whether the packet is of a first type corresponding to one of the rules stored at the switch portion. At 104, the packet is forwarded from the switch according to the rule stored at the switch based on a determination that the packet is of the first type corresponding to the rule stored at the switch. At 106, communication between the switch and the controller cache occurs based on a determination that the packet is of a second type that does not correspond to a rule stored at the switch. At 108, information stored at the controller cache is used to determine a manner of forwarding the packet based on a determination that the packet is of the second type. At 110, the determined manner of forwarding the packet is communicated from the controller cache to the switch. At 112, the switch forwards the packet according to that determined manner.

As can be appreciated from the preceding description, including an SDN controller cache at the location of a switch or in very close proximity to the switch reduces latency associated with reactive flow processing. This enhanced capability of an SDN switch facilitates more effective or efficient SDN network communications.

While various features and aspects are described above in connection with one or more particular embodiments, those features and aspects are not necessarily exclusive to the corresponding embodiment. The disclosed features and aspects may be combined in other ways than those specifically mentioned above. In other words, any feature of one embodiment may be included with or substituted for a feature of another embodiment.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A software-defined network (SDN) switch, comprising:
a switch portion including an input port for receiving at least one packet, the switch portion including an output port for forwarding the at least one packet, the switch portion including at least one stored rule, the switch portion forwarding the at least one packet based on the at least one stored rule based on a determination that the packet is of a first type corresponding to the stored rule; and
a controller cache including information indicating how the switch portion should forward the at least one packet based on a determination that the packet is of a second type that does not correspond to the at least one stored rule, the switch portion communicating with the controller cache to obtain an indication of how to forward the packet based on a determination that the packet is of the second type.

2. The switch of claim 1, wherein
the controller cache communicates with a SDN controller remote from the SDN switch;
the controller cache appears to the SDN controller as a SDN switch; and
the SDN controller and the controller cache communicate using a protocol for communications between the SDN controller and a SDN switch.

3. The switch of claim 2, wherein
the controller cache appears to the switch portion as a SDN controller; and
the controller cache and the switch portion communicate using a protocol for communications between a SDN controller and a SDN switch.

4. The switch of claim 1, wherein
the controller cache information comprises a plurality of rules for forwarding packets from the switch portion;
the at least one stored rule being at least one of a more recently used rule or a more frequently used rule compared to the plurality of rules of the controller cache information.

5. The switch of claim 1, wherein the controller cache information comprises at least one algorithm for dynamically determining how to forward a plurality of types of packets.

6. The switch of claim 5, wherein the at least one algorithm comprises a plurality of packet forwarding algorithms.

7. The switch of claim 6, wherein the cache processor uses the at least one algorithm and information from a separate source for determining how to forward the packet based on a determination that the packet is of the second type.

8. A communication system, comprising:
a software-defined network (SDN) switch including an input port for receiving at least one packet, the SDN switch including an output port for forwarding the at least one packet, the SDN switch including at least one stored rule, the SDN switch forwarding the at least one packet based on the at least one stored rule based on a determination that the packet is of a first type corresponding to the stored rule;
a SDN controller at a first communication distance from the SDN switch, the SDN controller including information indicating how the SDN switch should forward the at least one packet based on a determination that the packet is of a second type that does not correspond to the at least one stored rule; and
a controller cache at a second communication distance from the SDN switch, the second communication distance being less than the first communication distance, the controller cache including a duplicate of at least some of the information of the SDN controller, the SDN switch communicating with the controller cache based on a determination that the at least one packet is of the second type.

9. The system of claim 8, wherein the controller cache is collocated with the SDN switch.

10. The system of claim 8, wherein
the first communication distance comprises a first round trip time for communications between the SDN switch and the SDN controller; and
the second communication distance comprises a second, shorter round trip time for communications between the SDN switch and the controller cache.

11. The system of claim 8, wherein
the controller cache includes a processor;
the processor determines whether the information of the controller cache indicates how to forward the at least one packet when the packet is of the second type; and
the processor requests information from the SDN controller regarding how to forward the at least one packet based on a determination that the information of the controller cache does not indicate how to forward the at least one packet.

12. The system of claim 11, wherein
the processor requires information from a separate source; and
the SDN controller directs the information from the separate source to the controller cache.

13. The system of claim 8, wherein
the SDN controller information and the controller cache information respectively comprise a plurality of predetermined rules;
the controller cache appears to the SDN controller as a SDN switch; and
the SDN controller and the controller cache communicate using a protocol for communications between the SDN controller and a SDN switch.

14. The system of claim 8, wherein the SDN controller information and the controller cache information respectively comprise at least one algorithm for dynamically determining how to forward a plurality of types of packets.

15. The system of claim 8, wherein
the controller cache information comprises at least one of a predetermined rule and an algorithm for dynamically determining how to forward a packet; and
the SDN controller information comprises at least one of a predetermined rule and an algorithm for dynamically determining how to forward a packet.

16. A method of processing a packet at a switch in a software-defined network (SDN), comprising the steps of:
receiving at least one packet at the switch;
forwarding the at least one packet from the switch according to at least one stored rule stored at the switch based on a determination that the packet is of a first type corresponding to the stored rule;
communicating between the switch and a controller cache based on a determination that the packet is of a second type that does not correspond to the stored rule;
using information stored at the controller cache to determine a manner of forwarding the packet based on a determination that the packet is of the second type;
communicating the determined manner from the controller cache to the switch; and
forwarding the packet from the switch according to the determined manner.

17. The method of claim 16, comprising
communicating between the controller cache and a SDN controller remote from the switch;
wherein the controller cache appears to the SDN controller as a SDN switch; and
communicating between the SDN controller and the controller cache using a protocol for communications between the SDN controller and a SDN switch.

18. The method of claim 17, comprising
communicating between the controller cache and the switch portion using a protocol for communications between a SDN controller and a SDN switch;
wherein the controller cache appears to the switch as a SDN controller.

19. The method of claim 16, wherein
the controller cache information comprises a plurality of rules for forwarding packets from the switch portion;
the at least one stored rule is at least one of a more recently used rule or a more frequently used rule compared to the plurality of rules of the controller cache information.

20. The method of claim 16, comprising
dynamically determining the manner of forwarding based on at least one algorithm stored at the controller cache.
